(19) United States
(12) Patent Application Publication
(10) Pub. No.: US 2010/0257033 A1
(43) Pub. Date: Oct. 7, 2010

(54) SYSTEM AND METHOD OF CONDUCTING TRANSACTIONS USING A WIRELESS DEVICE

(75) Inventors: John R. Roberts, Beaverton, OR (US); Jose Ricardo Dos Santos, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/417,337

(22) Filed: Apr. 2, 2009

(51) Int. Cl. G06Q 30/00; G06Q 20/00

(52) U.S. Cl. 705/14.3; 705/21; 705/14.38

(57) ABSTRACT

A method of conduction transactions at a point-of-sale terminal using a wireless device is disclosed and may include attempting to read information from the point-of-sale terminal via a wireless link, receiving a merchant identification when an attempt to read is successful, and searching a payment table using the merchant identification. In a particular aspect, the merchant identification may include a merchant identification number, a merchant name, a merchant store number, or a combination thereof.

### FIELD

The present invention generally relates to wireless transactions, and more particularly, to conducting transactions using a wireless device.

### DESCRIPTION OF THE RELATED ART

As wireless devices evolve, they are being used more increasingly to conduct transactions with point-of-sale (POS) terminals. A user may store information related to particular merchants within a wireless device. When a POS terminal for a particular merchant is encountered, the user may have to manually search his or her wireless device for particular information related to the merchant and the transaction. This may be time consuming and off putting to customers.

Accordingly, what is needed is an improved system and method of conducting transactions using a wireless device.

### SUMMARY OF THE DISCLOSURE

A method of conduction transactions at a point-of-sale terminal using a wireless device is disclosed and may include attempting to read information from the point-of-sale terminal via a wireless link, receiving a merchant identification when an attempt to read is successful, and searching a payment table using the merchant identification. In a particular aspect, the merchant identification may include a merchant identification number, a merchant name, a merchant store number, or a combination thereof.

Further, the method may include determining whether the payment table includes a loyalty card and transmitting loyalty card information to the point-of-sale terminal when the payment table includes the loyalty card. The method may also include determining whether the payment table includes an electronic coupon and transmitting the electronic coupon to the point-of-sale terminal when the payment table includes the electronic coupon. Moreover, the method may include determining whether the payment table includes a merchant-defined payment method, retrieving the merchant-defined payment method when the payment table includes the merchant-defined payment method, and transmitting the merchant-defined payment to the point-of-sale terminal. Alternatively, the method may include determining whether the payment table includes a user-defined payment method, retrieving the merchant-defined payment method when the payment table includes the user-defined payment method, and transmitting the user-defined payment to the point-of-sale terminal.

In another aspect, a wireless device is disclosed and may include means for attempting to read information from a point-of-sale terminal via a wireless link, means for receiving a merchant identification when an attempt to read is successful, and means for searching a payment table using the merchant identification. The merchant identification may include a merchant identification number, a merchant name, a merchant store number, or a combination thereof.

In this aspect, the wireless device may further include means for determining whether the payment table includes a loyalty card and means for transmitting loyalty card information to the point-of-sale terminal when the payment table includes the loyalty card. Additionally, the wireless device may include means for determining whether the payment table includes an electronic coupon and means for transmitting the electronic coupon to the point-of-sale terminal when the payment table includes the electronic coupon. The wireless device may also include means for determining whether the payment table includes a merchant-defined payment method, means for retrieving the merchant-defined payment method when the payment table includes the merchant-defined payment method, and means for transmitting the merchant-defined payment to the point-of-sale terminal. Alternatively, the wireless device may include means for determining whether the payment table includes a user-defined payment method, means for retrieving the merchant-defined payment method when the payment table includes the user-defined payment method, and means for transmitting the user-defined payment to the point-of-sale terminal.

In yet another aspect, a wireless device is disclosed and may include a processor that is operable to attempt to read information from a point-of-sale terminal via a wireless link, to receive a merchant identification when an attempt to read is successful, and to search a payment table using the merchant identification. The merchant identification may include a merchant identification number, a merchant name, a merchant store number, or a combination thereof.

In this aspect, the processor within the wireless device may be further operable to determine whether the payment table includes a loyalty card and to transmit loyalty card information to the point-of-sale terminal when the payment table includes the loyalty card. The processor may also be operable to determine whether the payment table includes an electronic coupon and to transmitting the electronic coupon to the point-of-sale terminal when the payment table includes the electronic coupon. Further, the processor may be operable to determine whether the payment table includes a merchant-defined payment method, to retrieve the merchant-defined payment method when the payment table includes the merchant-defined payment method, and to transmit the merchant-defined payment to the point-of-sale terminal. Alternatively, the processor may be operable to determine whether the payment table includes a user-defined payment method, to retrieve the merchant-defined payment method when the payment table includes the user-defined payment method, and to transmit the user-defined payment to the point-of-sale terminal.

In still another aspect, a computer program product is disclosed and may include a computer-readable medium. The computer-readable medium may include at least one instruction for attempting to read information from a point-of-sale terminal via a wireless link, at least one instruction for receiving a merchant identification when an attempt to read is successful, and at least one instruction for searching a payment table using the merchant identification. The merchant identification may include a merchant identification number, a merchant name, a merchant store number, or a combination thereof.

The computer-readable medium may also include at least one instruction for determining whether the payment table includes a loyalty card and at least one instruction for transmitting loyalty card information to the point-of-sale terminal when the payment table includes the loyalty card. Further, the computer-readable medium may include at least one instruction for determining whether the payment table includes an electronic coupon and at least one instruction for transmitting the electronic coupon to the point-of-sale terminal when the payment table includes the electronic coupon.

In this aspect, the computer-readable medium may include at least one instruction for determining whether the payment table includes a merchant-defined payment method, at least one instruction for retrieving the merchant-defined payment method when the payment table includes the merchant-defined payment method, and at least one instruction for transmitting the merchant-defined payment to the point-of-sale terminal. Alternatively, the computer-readable medium may include at least one instruction for determining whether the payment table includes a user-defined payment method, at least one instruction for retrieving the merchant-defined payment method when the payment table includes the user-defined payment method, and at least one instruction for transmitting the user-defined payment to the point-of-sale terminal.

In another aspect, a method of processing transactions at a point-of-sale terminal is disclosed and may include detecting a wireless device via a wireless link and transmitting a merchant identification to the wireless device. The merchant identification may include a merchant identification number, a merchant name, a merchant store number, or a combination thereof. Further, the wireless link may be a near field communication link.

In this aspect, the method may further include receiving loyalty card information from the wireless device and searching a loyalty card database using the loyalty card information. The method may also include determining whether a loyalty card is approved and transmitting an approval acknowledgement or a disapproval acknowledgement. Moreover, the method may include receiving an electronic coupon from the wireless device, determining whether the electronic coupon is approved, and transmitting an approval acknowledgement or a disapproval acknowledgement.

In yet another aspect, a point-of-sale terminal is disclosed and may include means for detecting a wireless device via a wireless link and means for transmitting a merchant identification to the wireless device. The merchant identification may include a merchant identification number, a merchant name, a merchant store number, or a combination thereof. The wireless link may be a near field communication link.

The point-of-sale terminal may also include means for receiving loyalty card information from the wireless device and means for searching a loyalty card database using the loyalty card information. Further, the point-of-sale terminal may include means for determining whether a loyalty card is approved and means for transmitting an approval acknowledgement or a disapproval acknowledgement. The point-of-sale terminal may also include means for receiving an electronic coupon from the wireless device, means for determining whether the electronic coupon is approved, and means for transmitting an approval acknowledgement or a disapproval acknowledgement.

In still another aspect, a point-of-sale terminal is disclosed and may include a processor. The processor may be operable to detect a wireless device via a wireless link and to transmit a merchant identification to the wireless device. The merchant identification comprises a merchant identification number, a merchant name, a merchant store number, or a combination thereof. The wireless link may be a near field communication link.

The processor within the point-of-sale terminal may be further operable to receive loyalty card information from the wireless device and to search a loyalty card database using the loyalty card information. Further, the processor may be operable to determine whether a loyalty card is approved and to transmit an approval acknowledgement or a disapproval acknowledgement. The processor may also be operable to receive an electronic coupon from the wireless device, to determine whether the electronic coupon is approved, and to transmit an approval acknowledgement or a disapproval acknowledgement.

In another aspect, a computer program product is disclosed and may include a computer-readable medium. The computer-readable medium may include at least one instruction for detecting a wireless device via a wireless link and at least one instruction for transmitting a merchant identification to the wireless device. The merchant identification may include a merchant identification number, a merchant name, a merchant store number, or a combination thereof. The wireless link may be a near field communication link.

The computer-readable medium may further include at least one instruction for receiving loyalty card information from the wireless device and at least one instruction for searching a loyalty card database using the loyalty card information. Moreover, the computer-readable medium may include at least one instruction for determining whether a loyalty card is approved and at least one instruction for transmitting an approval acknowledgement or a disapproval acknowledgement. The computer-readable medium may also include at least one instruction for receiving an electronic coupon from the wireless device, at least one instruction for determining whether the electronic coupon is approved, and at least one instruction for transmitting an approval acknowledgement or a disapproval acknowledgement.

### BRIEF DESCRIPTION OF THE DRAWINGS

In the figures, like reference numerals refer to like parts throughout the various views unless otherwise indicated.

FIG. 1 is a diagram of a transaction system;

FIG. 2 is a diagram of a telephone;

FIG. 3 is a flowchart illustrating a first portion of a method of conducting transactions at a point-of-sale terminal with a wireless device;

FIG. 4 is a flowchart illustrating a second portion of a method of conducting transactions at a point-of-sale terminal with a wireless device;

FIG. 5 is a flowchart illustrating a third portion of a method of conducting transactions at a point-of-sale terminal with a wireless device;

FIG. 6 is a flowchart illustrating a fourth portion of a method of conducting transactions at a point-of-sale terminal with a wireless device;

FIG. 7 is a flowchart illustrating a first portion of a method of processing transactions at a point-of-sale terminal;

FIG. 8 is a flowchart illustrating a second portion of a method of processing transactions at a point-of-sale terminal; and

FIG. 9 is a flowchart illustrating a third portion of a method of processing transactions at a point-of-sale terminal.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, the terms “communication device,” “wireless device,” “wireless telephone,” “wireless communications device,” and “wireless handset” are used interchangeably. With the advent of third generation (3G) wireless technology, more bandwidth availability has enabled more electronic devices with wireless capabilities. Therefore, a wireless device could be a cellular telephone, a pager, a PDA, a smartphone, a navigation device, or a computer with a wireless connection.

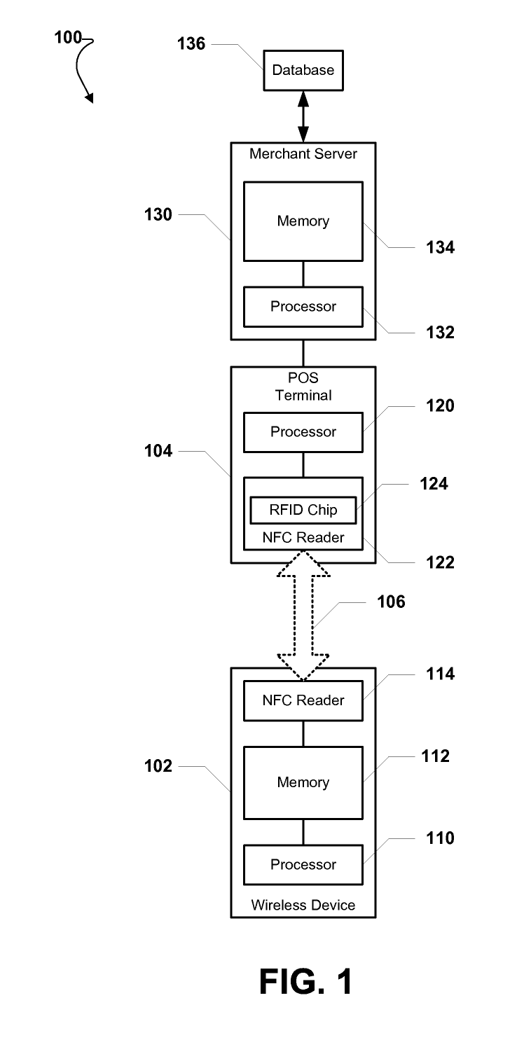

Referring to FIG. 1, a transaction system is shown and is designated 100. As shown, the transaction system 100 may include a wireless device 102 and a point-of-sale (POS) terminal 104. When the wireless device 102 is close to the POS terminal 104, the wireless device 102 may be connected to the POS terminal via a wireless connection 106. In a particular aspect, the wireless connection 106 may be provided by near field communication (NFC).

As shown in FIG. 1, the wireless device 102 may include a processor 110. A memory 112 may be connected to the processor 110. Further, an NFC reader 114 may be connected to the processor 110. In a particular aspect, the processor 110, the memory 112, the NFC reader 114, or a combination thereof may serve as a means for executing one or more of the method steps described herein.

The POS terminal 104 may also include a processor 120. An NFC reader 122 may be coupled to the processor 120. Moreover, the NFC reader 122 within the POS terminal 104 may include an RFID chip 124. The RFID chip 124 may be a FeliCa card, a FeliCa tag, a Mifare card, a Mifare tag, or a combination thereof. Alternatively, the RFID chip 124 may be an ISO 14443-compliant contactless card. In another aspect, the RFID chip 124 may be an ISO 18092-compliant contactless card. Otherwise, the RFID chip 124 may be another contactless card well known in the art.

In a particular aspect, the RFID chip 124 may include information related to a merchant, e.g., a merchant identification. The merchant identification may include a merchant identification number, a merchant name, a merchant store number, or a combination thereof. In a particular aspect, the processor 120, the NFC reader 122, the RFID chip 124 or a combination thereof may serve as a means for executing one or more of the method steps described herein.

As illustrated, the POS terminal 104 may be connected to a merchant server 130. The merchant server 130 may include a processor 132 and a memory 134 that may be connected to the processor 132. In a particular aspect, the processor 132, the memory 134, or a combination thereof may serve as a means for executing one or more of the method steps described herein. The merchant server 130 may also be connected to a database 136. The database 136 may include customer information, e.g., loyalty card information. Further, the database 136 may include coupon information.

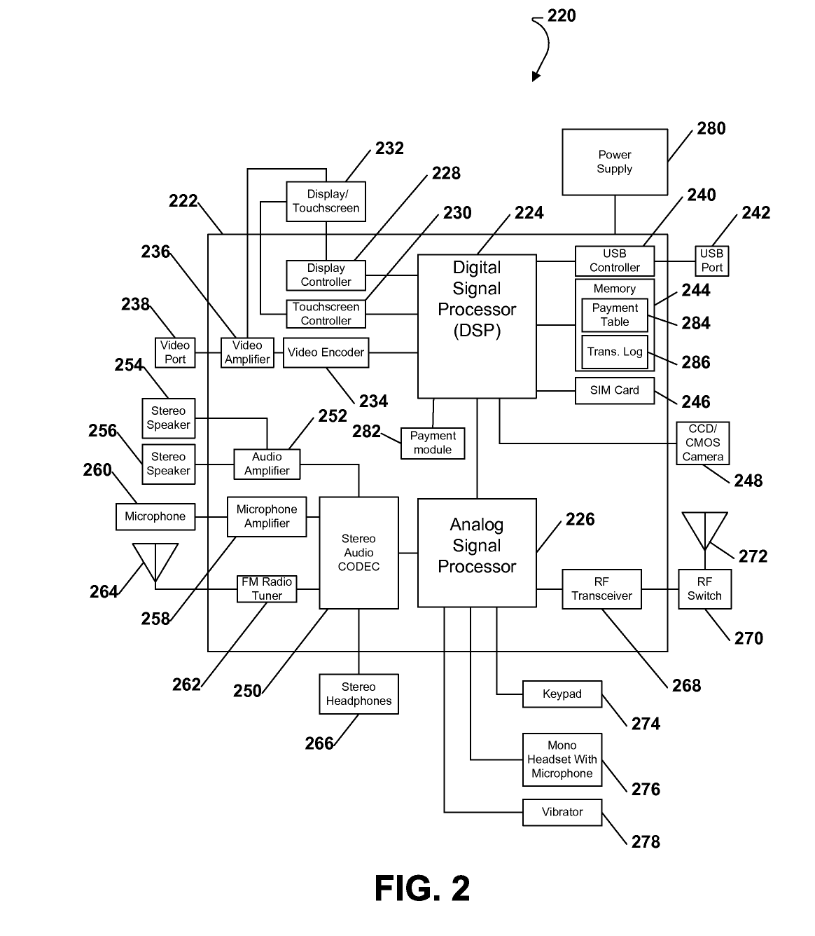

Referring to FIG. 2, an exemplary, non-limiting aspect of a wireless device is shown and is generally designated 220. As shown, the wireless device 220 includes an on-chip system 222 that includes a digital signal processor 224 and an analog signal processor 226 that are coupled together. As illustrated in FIG. 2, a display controller 228 and a touchscreen controller 230 are coupled to the digital signal processor 224. In turn, a touchscreen display 232 external to the on-chip system 222 is coupled to the display controller 228 and the touchscreen controller 230.

FIG. 2 further indicates that a video encoder 234, e.g., a phase alternating line (PAL) encoder, a sequential couleur a memoire (SECAM) encoder, or a national television system(s) committee (NTSC) encoder, is coupled to the digital signal processor 224. Further, a video amplifier 236 is coupled to the video encoder 234 and the touchscreen display 232. Also, a video port 238 is coupled to the video amplifier 236. As depicted in FIG. 2, a universal serial bus (USB) controller 240 is coupled to the digital signal processor 224. Also, a USB port 242 is coupled to the USB controller 240. A memory 244 and a subscriber identity module (SIM) card 246 may also be coupled to the digital signal processor 224. Further, as shown in FIG. 2, a digital camera 248 may be coupled to the digital signal processor 224. In an exemplary aspect, the digital camera 248 is a charge-coupled device (CCD) camera or a complementary metal-oxide semiconductor (CMOS) camera.

As further illustrated in FIG. 2, a stereo audio CODEC 250 may be coupled to the analog signal processor 226. Moreover, an audio amplifier 252 may coupled to the stereo audio CODEC 250. In an exemplary aspect, a first stereo speaker 254 and a second stereo speaker 256 are coupled to the audio amplifier 252. FIG. 2 shows that a microphone amplifier 258 may be also coupled to the stereo audio CODEC 250. Additionally, a microphone 260 may be coupled to the microphone amplifier 258. In a particular aspect, a frequency modulation (FM) radio tuner 262 may be coupled to the stereo audio CODEC 250. Also, an FM antenna 264 is coupled to the FM radio tuner 262. Further, stereo headphones 266 may be coupled to the stereo audio CODEC 250.

FIG. 2 further indicates that a radio frequency (RF) transceiver 268 may be coupled to the analog signal processor 226. An RF switch 270 may be coupled to the RF transceiver 268 and an RF antenna 272. As shown in FIG. 2, a keypad 274 may be coupled to the analog signal processor 226. Also, a mono headset with a microphone 276 may be coupled to the analog signal processor 226. Further, a vibrator device 278 may be coupled to the analog signal processor 226. FIG. 2 also shows that a power supply 280 may be coupled to the on-chip system 222. In a particular aspect, the power supply 280 is a direct current (DC) power supply that provides power to the various components of the wireless device 220 that require power. Further, in a particular aspect, the power supply is a rechargeable DC battery or a DC power supply that is derived from an alternating current (AC) to DC transformer that is connected to an AC power source.

FIG. 2 also shows that the wireless device 220 may include a payment module 282. Further, the wireless device 220 may include a payment table 284 and a transaction log 286 stored within the memory 244. In a particular aspect, the payment module 282 may serve as a means for executing one or more of the method steps described herein.

As depicted in FIG. 2, the touchscreen display 232, the video port 238, the USB port 242, the camera 248, the first stereo speaker 254, the second stereo speaker 256, the microphone 260, the FM antenna 264, the stereo headphones 266, the RF switch 270, the RF antenna 272, the keypad 274, the mono headset 276, the vibrator 278, and the power supply 280 are external to the on-chip system 222.

In a particular aspect, one or more of the method steps described herein may be stored in the memory 244 as computer program instructions. These instructions may be executed by a processor 224, 226 in order to perform the methods described herein. Further, the processors, 224, 226, the memory 244, the instructions stored therein, or a combination thereof may serve as a means for performing one or more of the method steps described herein.

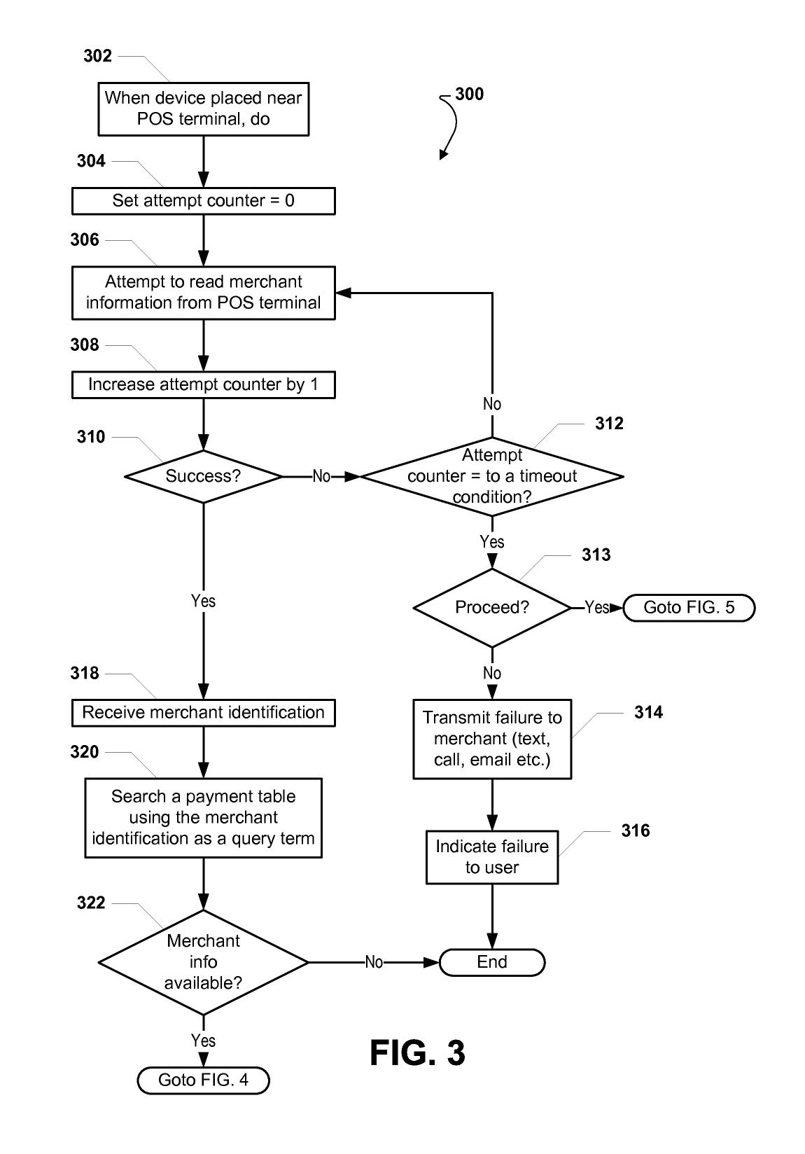

Referring now to FIG. 3 through FIG. 6, a method of receiving merchant information at a wireless device is shown and is generally designated 300. The method 300 commences at block 302 with a do loop in which when a wireless device placed near a point-of-sale (POS) terminal, the following steps are performed. At block 304, an attempt counter within the wireless device is set equal to zero (0). At block 306, the wireless device may attempt to read merchant information from the POS terminal. In a particular aspect, the wireless device may attempt to read the merchant information via a wireless link. For example, the wireless link may be established using NFC.

Moving to block 308, the attempt counter may be increased by one (1) integer. At decision 310, the wireless device may determine whether the wireless device has made successful contact with the POS terminal. If not, the method 300 may proceed to decision 312. At decision 312, the wireless device may determine whether the attempt counter is equal to a timeout condition. The timeout condition may be threshold number of attempts, e.g., 2, 3, 4, 5, 6, or N etc. attempts. The timeout condition may be user-defined or the timeout condition may be set during the provisioning of the wireless device.

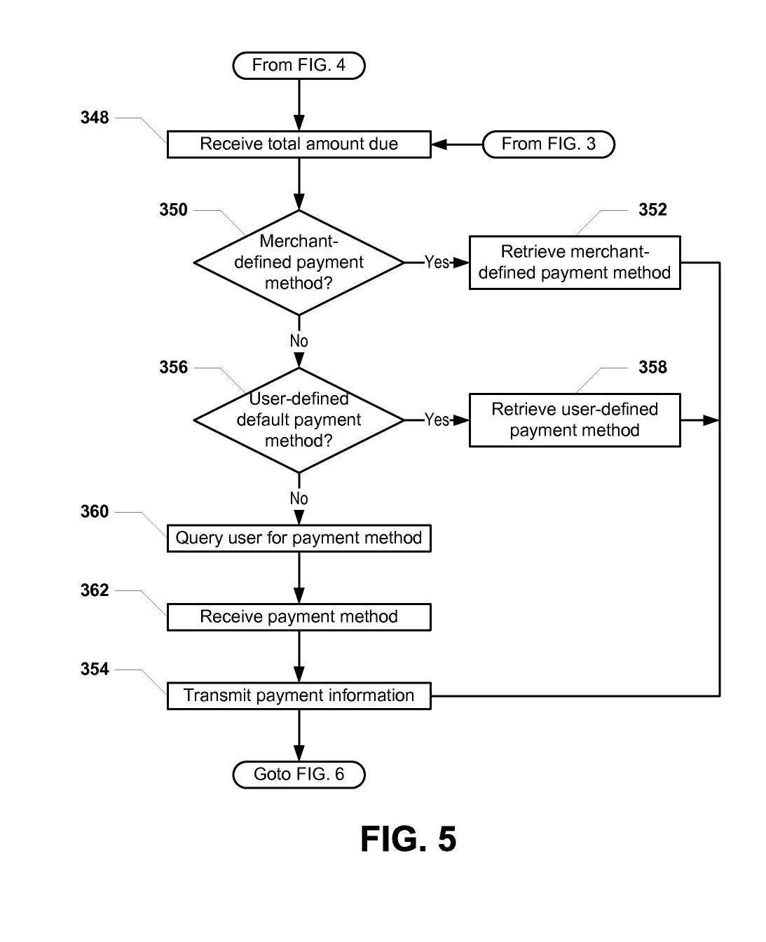

If the attempt counter does not equal the timeout condition, the method 300 may return to block 306 and continue as described herein. Otherwise, if the attempt counter equals the timeout condition, the method 300 may continue to decision 313. At decision 313, the payment module may determine whether to proceed with the transaction without the merchant information. This determination may be made by querying the user of the wireless device that initiated the transaction. If the payment module determines to proceed, the method may continue to block 348 of FIG. 5 and continue as described herein. Otherwise, if the payment module determines not to proceed with the transaction, the method 300 may continue to block 314.

At block 314, the wireless device may transmit a failure message to a merchant that owns the POS terminal. The message may be a text message, a call, an email, or a combination thereof. Further, the message may be automatically generated by the wireless device and sent to the merchant. From block 314, the method 300 may proceed to block 316 and the wireless device may indicate a failure message to the user, e.g., via a display on the wireless device. The method 300 may then end.

Returning to decision 310, if the wireless device has made successful contact with the POS terminal, the method 300 may proceed to block 318 and the wireless device may receive merchant identification from the POS terminal. The merchant identification may include a merchant identification number, a merchant name, a merchant store number, or a combination thereof. Thereafter, at block 320, the wireless device, e.g., the payment module therein, may search a payment table stored within the wireless device using the merchant identification as a query term.

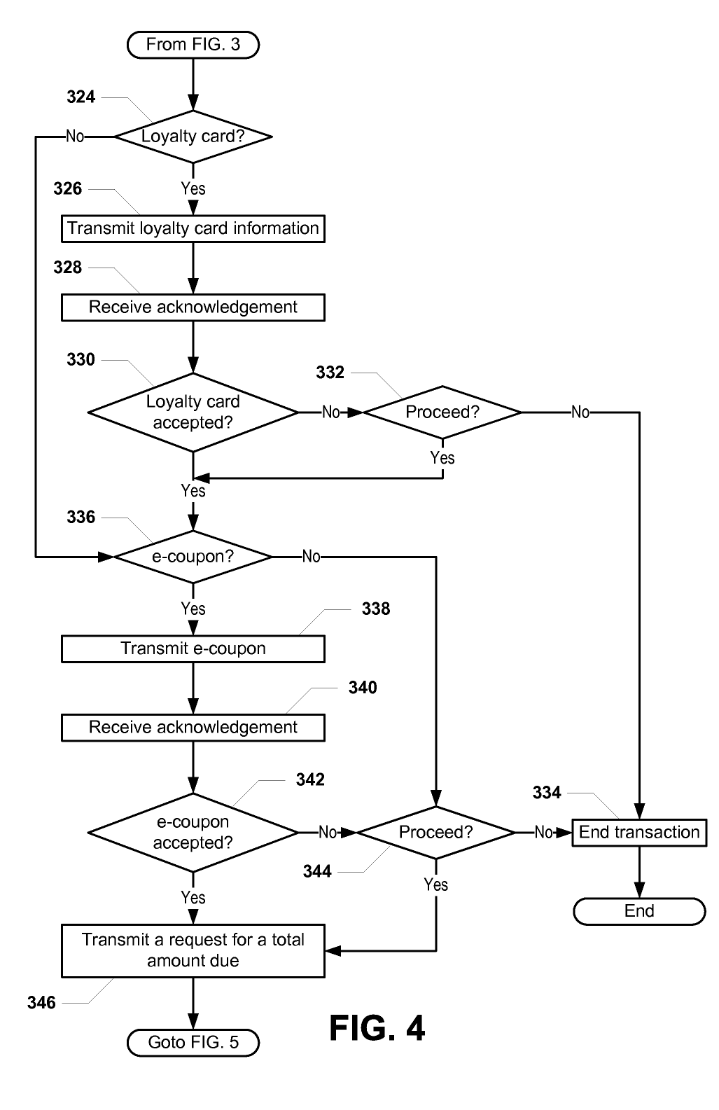

Moving to decision 322, the payment module may determine whether any merchant information is available from the payment table. If not, the method 300 may end. Otherwise, the method 300 may proceed to decision 324 of FIG. 4.

At decision 324, the payment module may determine whether the merchant information includes a loyalty card for the merchant. If so, the method 300 may proceed to block 326 and the payment module may transmit the loyalty card information to the POS terminal. Thereafter, the payment module may receive an acknowledgement from the POS terminal. At decision 330, the payment module may determine whether the loyalty card is accepted by the POS terminal, e.g., based on the acknowledgement received from the POS terminal. If the loyalty card is not accepted by the POS terminal, the method 300 may proceed to decision 332 and the payment module may determine whether to proceed with the transaction. This determination may be made by querying the user of the wireless device that initiated the transaction. If the payment module determines not to proceed, the method 300 may continue to block 334 and the transaction may be ended by the payment module. Thereafter, the method 300 may end.

Returning to decision 330, if the loyalty card is accepted, the method 300 may proceed to decision 336. Further, returning to decision 324, if the merchant information obtained from the payment table does not include a loyalty card, the method 300 may move directly to decision 336.

At decision 336, the payment module may determine whether the merchant information includes an e-coupon for the item which the user of the wireless device is attempting to purchase. If the merchant information includes an e-coupon, the method 300 may proceed to block 338 and the e-coupon may be transmitted to the POS terminal. Thereafter, the payment module may receive an acknowledgement from the POS terminal at block 340.

Proceeding to decision 342, the payment module may determine whether the e-coupon is accepted by the POS terminal. If not, the method 300 may move to decision 344 and the payment module may determine whether to continue with the transaction, e.g., by querying the user via the user interface of the wireless device. If the payment module determines not to proceed, the method 300 may move to block 334 and continue as described herein. Otherwise, the method 300 may proceed to block 346.

Returning to decision 342, if the e-coupon is not accepted, the method 300 may also move to block 346. At block 346, the payment module may transmit a request for a total amount due to the POS terminal. Thereafter, the method 300 may continue to block 348 of FIG. 5. Returning to decision 336, if the merchant information does not include an e-coupon, the method 300 may continue to decision 344 and continue as described herein.

At block 348, the payment module within the wireless device may receive the total amount due from the POS terminal. Next, at decision 350, the payment module may determine whether the merchant information obtained from the payment table includes a merchant-defined payment method. For example, a particular merchant may only allow a user to pay via a debit card. Further, a merchant may only allow a user to pay using a credit card. Also, a merchant may only accept a particular type of credit card, e.g., Visa, MasterCard, Discover Card, American Express, etc. In another aspect, a merchant may only accept payment via an electronic fund transfer (EFT) or via third party payment system, e.g., PayPal. In the case in which the wireless device is unable to read the merchant information from the POS terminal at block 306, the payment module will be unable to query the payment table using a merchant identification to determine whether the merchant information obtained from the payment table includes a merchant-defined payment method and the method 300 may proceed directly to decision 356 and continue as described herein.

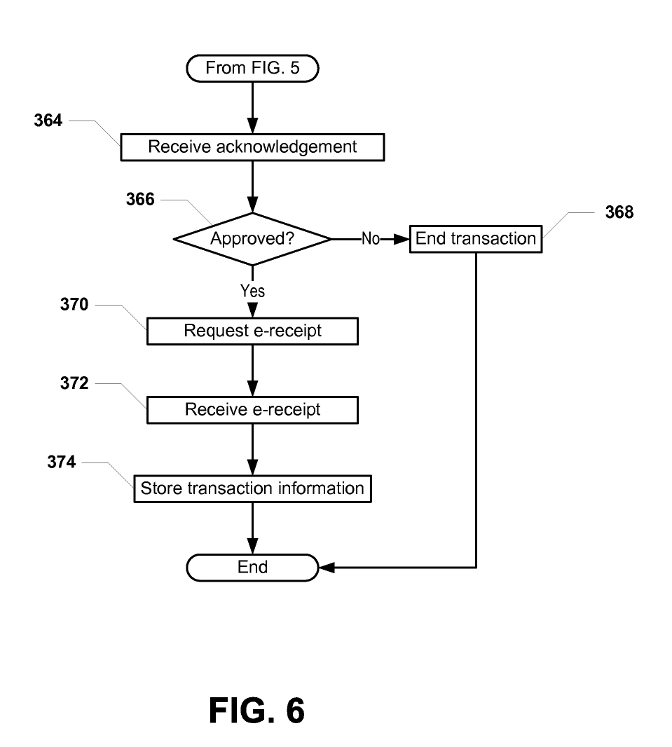

At decision 350, if the merchant information includes a merchant-defined payment method, the payment module may retrieve the merchant defined payment method from the payment table. Thereafter, the method 300 may proceed to block 354 and the payment module may transmit the payment information to the POS terminal. The method 300 may then proceed to block 364 of FIG. 6.

Returning to decision 350, if the merchant information does not include a merchant-defined payment method, the method 300 may proceed to decision step 356 and the payment module may determine whether the payment table includes a user-defined default payment, e.g., from a particular account. If so, the method 300 may continue to block 358 and the payment module may retrieve the user-defined payment method from the payment table. Thereafter, the method 300 may continue to block 354 and continue as described herein.

Returning to decision 356, if the payment table does not include a user-defined default payment method, the method 300 may proceed to block 360 and the payment module may query the user for payment information, e.g., using the user interface provided by the wireless device. Thereafter, at block 362, the payment module may receive the payment method from the user. The method 300 may then continue to block 354 and continue as described herein.

Proceeding to block 364 of FIG. 6, after the payment module transmits payment information to the POS terminal, the payment module may receive an acknowledgement from the POS terminal. Next, at decision step 366 the payment module may determine whether payment has been approved or accepted, e.g., based on the acknowledgment from the POS terminal. If payment is not approved, the method 300 may move to block 368 and the payment module may end the transaction. Thereafter, the method 300 may end.

Returning to decision 366, if the payment is approved, the method 300 may continue to block 370 and the payment module may request a receipt, e.g., an electronic receipt (e-receipt), from the POS terminal. At block 372, the payment module may receive the e-receipt from the POS terminal. Moreover, at block 374, the payment module may store transaction information at the wireless device, e.g., within a transaction history log. The transaction information may include the merchant identification, the payment method used, e-coupon information, loyalty card information, a transaction amount, a transaction date, a transaction time, the e-receipt, or a combination thereof. The method 300 may then end.

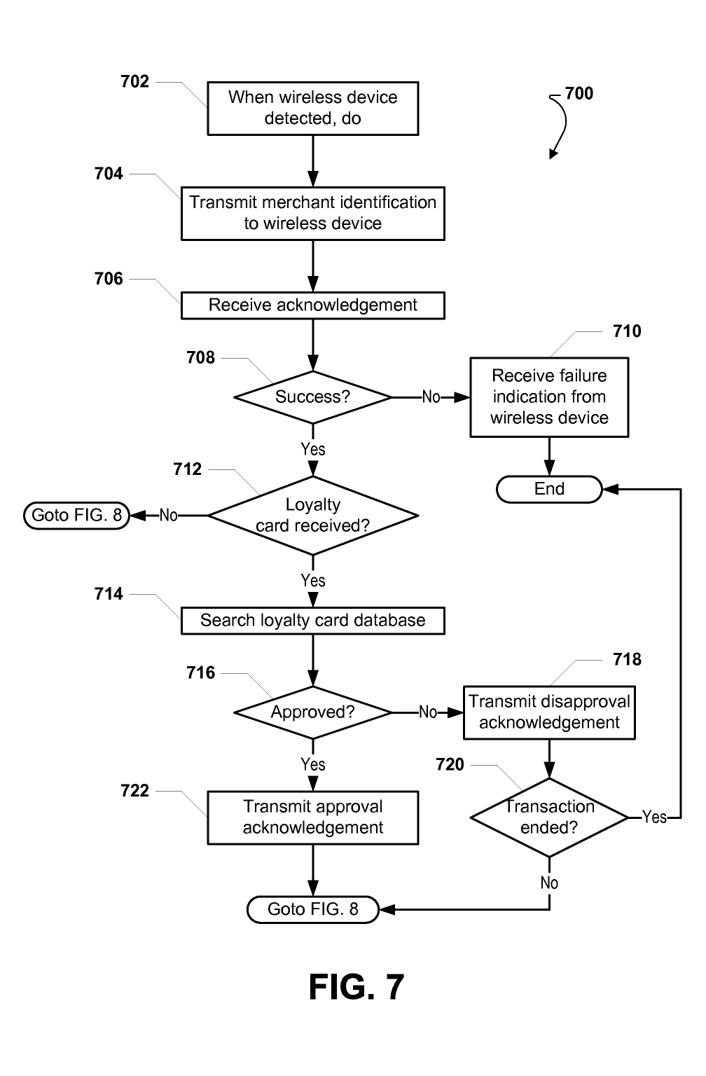

Referring to FIG. 7 through FIG. 9, a method of transmitting merchant information to a wireless device is shown and is generally designated 700. Beginning at block 702, a do loop is entered in which when a wireless device is detected at a POS terminal, e.g., via near field communication (NFC), the following steps may be performed. At block 704, the POS terminal may transmit a merchant identification to a wireless device. The merchant identification may include a merchant identification number, a merchant name, a merchant store number, or a combination thereof. Further, at block 706, the POS terminal may receive an acknowledgement from the wireless device. Thereafter, at decision 708, the POS terminal may determine whether the transmission of the merchant information to the wireless device was successful, e.g., based on the acknowledgement from the wireless device. If the transmission is not successful, the method 700 may proceed to block 710 and the POS terminal may receive a failure indication from the wireless device. The failure indication may be received via NFC, text, email, voicemail, or a combination thereof.

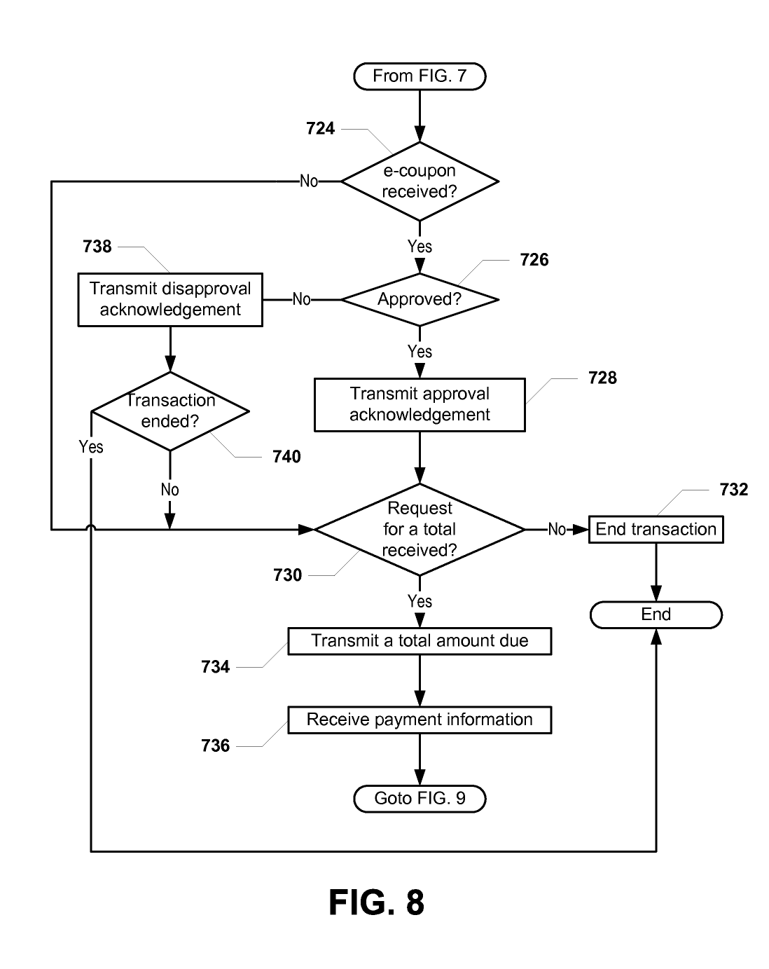

Returning to decision 708, if the transmission of the merchant information is successful, the method 700 may proceed to decision 712. At decision 712, the POS terminal may determine whether a loyalty card is received. If not, the method 700 may proceed to decision 722 of FIG. 8. Otherwise, the method 700 may proceed to block 714 and the POS terminal may search a loyalty card database to locate the loyalty card to determine if the loyalty card is legitimate and approved. Moving to decision 716, the POS terminal may determine whether the loyalty card is approved, e.g., based on the previous search. If the loyalty card is not approved, the method 700 may continue to block 718 and the POS terminal may transmit a disapproval acknowledgement to the wireless device. Thereafter, the POS terminal may determine whether the transaction has been ended by the wireless device, e.g., based on an acknowledgement, or request, received from the wireless device. If so, the method 700 may end. Otherwise, if the transaction is not ended, the method 700 may continue to decision 724 of FIG. 8.

Returning to decision 716, if the loyalty card is approved by the POS terminal, the method 700 may proceed to block 722. At block 722, the POS terminal may transmit an approval acknowledgement to the wireless device. Then, the method 700 may proceed to decision 724 of FIG. 8.

At decision 724 of FIG. 8, the POS terminal may determine whether an electronic coupon (e-coupon) is received from the wireless device. At decision 726, the POS terminal may determine whether the e-coupon is valid and approved. If so, the method 700 may continue to block 728 and the POS terminal may transmit an approval acknowledgement. Thereafter, at decision 730, the POS terminal may determine whether a request for a total amount due is received. If not, the method 700 may move to block 732 and the POS terminal may end the transaction. Then, the method 700 may end.

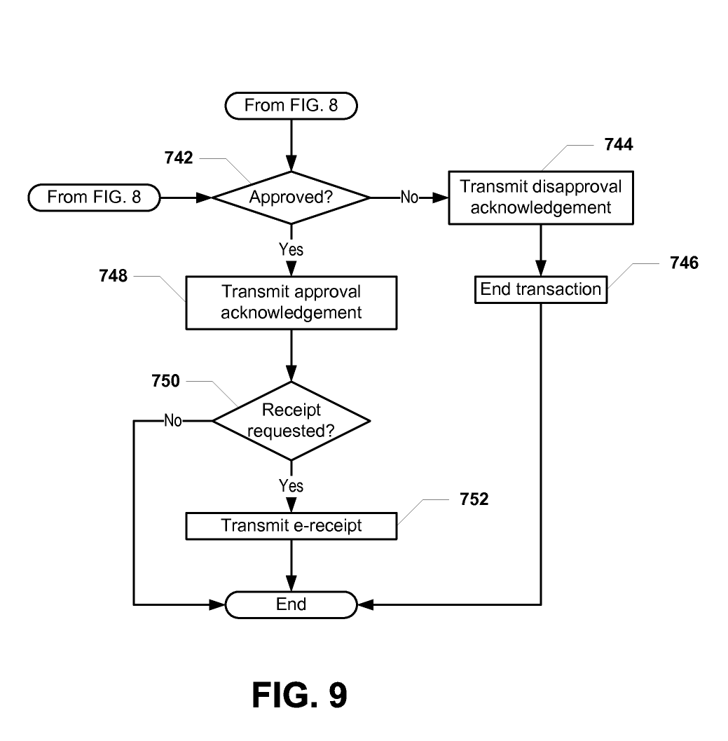

Returning to decision 730, if a request for a total is received, the method 700 may move to block 734 and the POS may transmit a total amount due. Next, payment information may be received at block 736. The method 700 may then proceed to decision 742 of FIG. 9.

Returning to decision 726, if the e-coupon is not valid and approved, the method 700 may continue to block 738 and the POS terminal may transmit a disapproval acknowledgement. Thereafter, the POS terminal may determine whether the transaction has been ended, e.g., based on a request received from the wireless device. If the transaction is not ended, the method 700 may move to decision 730 and continue as described herein. Otherwise, if the transaction is ended by the user of the wireless device, the method 700 may end.

Returning to decision 724, if an e-coupon is not received from the wireless device, the method 700 may proceed directly to decision 730 and continue as described herein.

Moving to decision 742 of FIG. 9, the POS terminal may determine whether the payment method is approved. If not, the method 700 may proceed to block 744 and the POS terminal may transmit a disapproval acknowledgement. Next, the POS terminal may end the transaction at block 746. The method 700 may then end.

Returning to decision 742, if the payment method is approved, the method 700 may continue to block 748 and the POS terminal may transmit an approval acknowledgement to the wireless device. At decision step 750, the POS terminal may determine whether a receipt is requested. If not, the method 700 may end. If a receipt is requested, the method 700 may proceed to block 752 and the POS terminal may transmit an e-receipt to the wireless device. Then, the method 700 may end.

It is to be understood that the method steps described herein do not necessarily have to be performed in the order as described. Further, words such as “thereafter”, “then”, “next”, etc. are not intended to limit the order of the steps. These words are simply used to guide the reader through the description of the method steps.

With the configuration described herein, the system and method disclosed herein provides a relatively easy way for a user to shop using a wireless device. The wireless device may communicate with a POS terminal. The POS terminal may transmit merchant information to the wireless device. The merchant information may include a merchant name, a merchant identification number, a merchant address, a merchant type, or a combination thereof.

Based on the merchant information, the wireless device, e.g., a payment module therein, may search a payment table using the merchant information as a query term, or terms. The wireless device may perform the search in order to locate a loyalty card, an e-coupon, a merchant-defined method of payment, a user-defined method of payment, or a combination thereof. The need for a user to manually locate this information is obviated through the use of the merchant information in conjunction with the payment table.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of conduction transactions at a point-of-sale terminal using a wireless device, the method comprising:
attempting to read information from the point-of-sale terminal via a wireless link;
receiving a merchant identification when an attempt to read is successful; and
searching a payment table using the merchant identification.

2. The method of claim 1, wherein the merchant identification comprises a merchant identification number, a merchant name, a merchant store number, or a combination thereof.

3. The method of claim 1, further comprising:
determining whether the payment table includes a loyalty card; and
transmitting loyalty card information to the point-of-sale terminal when the payment table includes the loyalty card.

4. The method of claim 3, further comprising:
determining whether the payment table includes an electronic coupon; and
transmitting the electronic coupon to the point-of-sale terminal when the payment table includes the electronic coupon.

5. The method of claim 4, further comprising:
determining whether the payment table includes a merchant-defined payment method;
retrieving the merchant-defined payment method when the payment table includes the merchant-defined payment method; and
transmitting the merchant-defined payment to the point-of-sale terminal.

6. The method of claim 4, further comprising:
determining whether the payment table includes a user-defined payment method;
retrieving the merchant-defined payment method when the payment table includes the user-defined payment method; and
transmitting the user-defined payment to the point-of-sale terminal.

7. A wireless device, comprising:
means for attempting to read information from a point-of-sale terminal via a wireless link;
means for receiving a merchant identification when an attempt to read is successful; and
means for searching a payment table using the merchant identification.

8. The wireless device of claim 7, wherein the merchant identification comprises a merchant identification number, a merchant name, a merchant store number, or a combination thereof.

9. The wireless device of claim 7, further comprising:
means for determining whether the payment table includes a loyalty card; and
means for transmitting loyalty card information to the point-of-sale terminal when the payment table includes the loyalty card.

10. The wireless device of claim 9, further comprising:
means for determining whether the payment table includes an electronic coupon; and
means for transmitting the electronic coupon to the point-of-sale terminal when the payment table includes the electronic coupon.

11. The wireless device of claim 10, further comprising:
means for determining whether the payment table includes a merchant-defined payment method;
means for retrieving the merchant-defined payment method when the payment table includes the merchant-defined payment method; and
means for transmitting the merchant-defined payment to the point-of-sale terminal.

12. The wireless device of claim 10, further comprising:
means for determining whether the payment table includes a user-defined payment method;
means for retrieving the merchant-defined payment method when the payment table includes the user-defined payment method; and
means for transmitting the user-defined payment to the point-of-sale terminal.

13. A wireless device, comprising:
a processor operable to:
attempt to read information from a point-of-sale terminal via a wireless link;
receive a merchant identification when an attempt to read is successful; and
search a payment table using the merchant identification.

14. The wireless device of claim 13, wherein the merchant identification comprises a merchant identification number, a merchant name, a merchant store number, or a combination thereof.

15. The wireless device of claim 13, wherein the processor is further operable to:
determine whether the payment table includes a loyalty card; and
transmit loyalty card information to the point-of-sale terminal when the payment table includes the loyalty card.

16. The wireless device of claim 15, wherein the processor is further operable to:
determine whether the payment table includes an electronic coupon; and
transmit the electronic coupon to the point-of-sale terminal when the payment table includes the electronic coupon.

17. The wireless device of claim 16, wherein the processor is further operable to:
determine whether the payment table includes a merchant-defined payment method;
retrieve the merchant-defined payment method when the payment table includes the merchant-defined payment method; and
transmit the merchant-defined payment to the point-of-sale terminal.

18. The wireless device of claim 16, wherein the processor is further operable to:
determine whether the payment table includes a user-defined payment method;
retrieve the merchant-defined payment method when the payment table includes the user-defined payment method; and
transmit the user-defined payment to the point-of-sale terminal.

19. A computer program product, comprising:
a computer-readable medium, comprising:
at least one instruction for attempting to read information from a point-of-sale terminal via a wireless link;
at least one instruction for receiving a merchant identification when an attempt to read is successful; and
at least one instruction for searching a payment table using the merchant identification.

20. The computer program product of claim 19, wherein the merchant identification comprises a merchant identification number, a merchant name, a merchant store number, or a combination thereof.

21. The computer program product of claim 19, wherein the computer-readable medium further comprises:
at least one instruction for determining whether the payment table includes a loyalty card; and
at least one instruction for transmitting loyalty card information to the point-of-sale terminal when the payment table includes the loyalty card.

22. The computer program product of claim 21, wherein the computer-readable medium further comprises:
at least one instruction for determining whether the payment table includes an electronic coupon; and
at least one instruction for transmitting the electronic coupon to the point-of-sale terminal when the payment table includes the electronic coupon.

23. The computer program product of claim 22, wherein the computer-readable medium further comprises:
at least one instruction for determining whether the payment table includes a merchant-defined payment method;
at least one instruction for retrieving the merchant-defined payment method when the payment table includes the merchant-defined payment method; and
at least one instruction for transmitting the merchant-defined payment to the point-of-sale terminal.

24. The computer program product of claim 22, wherein the computer-readable medium further comprises:
at least one instruction for determining whether the payment table includes a user-defined payment method;
at least one instruction for retrieving the merchant-defined payment method when the payment table includes the user-defined payment method; and
at least one instruction for transmitting the user-defined payment to the point-of-sale terminal.

25. A method of processing transactions at a point-of-sale terminal, the method comprising:
detecting a wireless device via a wireless link; and
transmitting a merchant identification to the wireless device.

26. The method of claim 25, wherein the merchant identification comprises a merchant identification number, a merchant name, a merchant store number, or a combination thereof.

27. The method of claim 25, wherein the wireless link is a near field communication link.

28. The method of claim 25, further comprising:
receiving loyalty card information from the wireless device; and
searching a loyalty card database using the loyalty card information.

29. The method of claim 28, further comprising:
determining whether a loyalty card is approved; and
transmitting an approval acknowledgement or a disapproval acknowledgement.

30. The method of claim 29, further comprising:
receiving an electronic coupon from the wireless device;
determining whether the electronic coupon is approved; and
transmitting an approval acknowledgement or a disapproval acknowledgement.

31. A point-of-sale terminal, comprising:
means for detecting a wireless device via a wireless link; and
means for transmitting a merchant identification to the wireless device.

32. The point-of-sale terminal of claim 31, wherein the merchant identification comprises a merchant identification number, a merchant name, a merchant store number, or a combination thereof.

33. The point-of-sale terminal of claim 31, wherein the wireless link is a near field communication link.

34. The point-of-sale terminal of claim 31, further comprising:
means for receiving loyalty card information from the wireless device; and
means for searching a loyalty card database using the loyalty card information.

35. The point-of-sale terminal of claim 34, further comprising:
means for determining whether a loyalty card is approved; and
means for transmitting an approval acknowledgement or a disapproval acknowledgement.

36. The point-of-sale terminal of claim 35, further comprising:
means for receiving an electronic coupon from the wireless device;
means for determining whether the electronic coupon is approved; and
means for transmitting an approval acknowledgement or a disapproval acknowledgement.

37. A point-of-sale terminal, comprising:
a processor, wherein the processor is operable to:
detect a wireless device via a wireless link; and
transmit a merchant identification to the wireless device.

38. The point-of-sale terminal of claim 37, wherein the merchant identification comprises a merchant identification number, a merchant name, a merchant store number, or a combination thereof.

39. The point-of-sale terminal of claim 37, wherein the wireless link is a near field communication link.

40. The point-of-sale terminal of claim 37, wherein the processor is further operable to:
receive loyalty card information from the wireless device; and
search a loyalty card database using the loyalty card information.

41. The point-of-sale terminal of claim 40, wherein the processor is further operable to:
determine whether a loyalty card is approved; and
transmit an approval acknowledgement or a disapproval acknowledgement.

42. The point-of-sale terminal of claim 41, wherein the processor is further operable to:
receive an electronic coupon from the wireless device;
determine whether the electronic coupon is approved; and
transmit an approval acknowledgement or a disapproval acknowledgement.

43. A computer program product, comprising:
a computer-readable medium, comprising:
at least one instruction for detecting a wireless device via a wireless link; and
at least one instruction for transmitting a merchant identification to the wireless device.

44. The point-of-sale terminal of claim 43, wherein the merchant identification comprises a merchant identification number, a merchant name, a merchant store number, or a combination thereof.

45. The point-of-sale terminal of claim 43, wherein the wireless link is a near field communication link.

46. The point-of-sale terminal of claim 43, wherein the computer-readable medium further comprises:
at least one instruction for receiving loyalty card information from the wireless device; and
at least one instruction for searching a loyalty card database using the loyalty card information.

47. The point-of-sale terminal of claim 46, wherein the computer-readable medium further comprises:
at least one instruction for determining whether a loyalty card is approved; and
at least one instruction for transmitting an approval acknowledgement or a disapproval acknowledgement.

48. The point-of-sale terminal of claim 47, wherein the computer-readable medium further comprises:
at least one instruction for receiving an electronic coupon from the wireless device;
at least one instruction for determining whether the electronic coupon is approved; and
at least one instruction for transmitting an approval acknowledgement or a disapproval acknowledgement.
